(19) United States
(12) Patent Application Publication
(10) Pub. No.: US 2015/0268114 A1
(43) Pub. Date: Sep. 24, 2015

(54) PHYSICAL QUANTITY SENSOR, METHOD FOR MANUFACTURING PHYSICAL QUANTITY SENSOR, PRESSURE SENSOR, ALTIMETER, ELECTRONIC DEVICE, AND MOVING OBJECT

(71) Applicant: Seiko Epson Corporation, Tokyo (JP)

(72) Inventor: Masahiro TAKEUCHI, Chino (JP)

(21) Appl. No.: 14/665,464

(22) Filed: Mar. 23, 2015

(30) Foreign Application Priority Data
Mar. 24, 2014 (JP) 2014-059811

(51) Int. Cl. G01L 9/00

(52) U.S. Cl. CPC G01L 9/0054

(57) ABSTRACT

A physical quantity sensor includes a substrate, a piezoresistive element, and a laminated structure. The substrate has a diaphragm portion deformed flexibly when receiving pressure. The piezoresistive element is arranged on one surface of the diaphragm portion. The laminated structure is arranged on the piezoresistive element side of the diaphragm portion and constitutes with the diaphragm portion a cavity portion that is a pressure reference chamber. The laminated structure is formed by using a CMOS process.

### BACKGROUND

1. Technical Field

The present invention relates to a physical quantity sensor, a method for manufacturing the physical quantity sensor, a pressure sensor, an altimeter, an electronic device, and a moving object.

2. Related Art

A pressure sensor is widely used that is provided with a diaphragm deformed flexibly when receiving pressure. Such a pressure sensor is known to detect the pressure exerted on the diaphragm in a manner in which a piezoresistive element is arranged on the diaphragm, and a sensor element detects the curvature of the diaphragm (for example, refer to JP-A-2001-332746).

For example, the pressure sensor disclosed in JP-A-2001-332746 includes a silicon wafer and a substrate that are bonded together. A recess portion is formed on the surface of the substrate on the silicon wafer side in order to form a cavity portion (pressure reference chamber) between the silicon wafer and the substrate. Then, the silicon wafer is thinned so that the part of the silicon wafer corresponding to the cavity portion constitutes the diaphragm. In addition, a strain sensing element (piezo resistor) is formed on the surface of the diaphragm on the cavity portion side.

However, in the manufacture of the pressure sensor disclosed in JP-A-2001-332746, the silicon wafer has to be bonded to the substrate having the recess portion after the strain sensing element is formed in the silicon wafer. When there is a positional dislocation during the bonding of the silicon wafer and the substrate, the accuracy of positioning the diaphragm and the strain sensing element may decrease, and consequently, this poses a problem of causing variations in the pressure reception sensitivity. In addition, another problem is that it is difficult to decrease the pressure sensor in size.

### SUMMARY

An advantage of some aspects of the invention is to provide a physical quantity sensor and a method for manufacturing the same in which the accuracy of positioning a diaphragm portion and a strain resistance element can be increased, and the physical quantity sensor can be decreased in size and to provide a pressure sensor, an altimeter, an electronic device, and a moving object, all of which are provided with the physical quantity sensor.

The advantage can be achieved by the following configurations.

### Application Example 1

A physical quantity sensor according to this application example includes a substrate that includes a diaphragm portion deformed flexibly when receiving pressure, an element that is arranged in the diaphragm portion and outputs a signal in response to a strain, and a wall portion that constitutes a pressure reference chamber with the diaphragm portion, in which the wall portion includes a wiring layer.

According to the physical quantity sensor, the pressure reference chamber (wall portion) is formed by using a CMOS process. This can increase the accuracy of positioning the diaphragm portion, the element having a strain resistance, and the pressure reference chamber and can decrease the physical quantity sensor in size.

### Application Example 2

It is preferable that the physical quantity sensor according to the application example further includes an insulating film that is arranged between the element and the pressure reference chamber.

This configuration can prevent the element having a strain resistance and the wiring thereof from being short-circuited even when the part of the wall portion facing the diaphragm portion (ceiling portion) has conductivity, bends inward, and comes in contact with the diaphragm portion.

### Application Example 3

In the physical quantity sensor according to the application example, it is preferable that the insulating film includes a silicon nitride film.

The silicon nitride film has not only insulating characteristics but also a resistance to buffered hydrofluoric acid and the like. Accordingly, the silicon nitride film can be used as an etching stopper layer when the pressure reference chamber is formed by etching a silicon oxide film with buffered hydrofluoric acid and the like.

### Application Example 4

In the physical quantity sensor according to the application example, it is preferable that the insulating film includes a silicon oxide film that is arranged between the silicon nitride film and the element detecting a strain.

The silicon oxide film has insulating characteristics. Arranging the silicon oxide film between the silicon nitride film and the element detecting a strain can reduce stress between the silicon nitride film and the element having a strain resistance.

### Application Example 5

In the physical quantity sensor according to the application example, it is preferable that the wall portion has a part that includes a conductive material and overlaps the element in a plan view from the thickness direction of the diaphragm portion.

In this case, the part of the wall portion facing the diaphragm portion (ceiling portion) has conductivity. For this, the effect obtained by arranging the insulating film between the element detecting a strain and the pressure reference chamber is suitably exhibited.

### Application Example 6

It is preferable that the physical quantity sensor according to the application example further includes a corrosion-resistant film that is arranged between the element and the pressure reference chamber and has a corrosion resistance to buffered hydrofluoric acid.

According to this configuration, the corrosion-resistant film can be used as an etching stopper layer when the pressure reference chamber is formed by etching a silicon oxide film with buffered hydrofluoric acid and the like.

### Application Example 7

A method for manufacturing a physical quantity sensor according to this application example includes forming on one surface of a substrate an element that outputs a signal in response to a strain, forming a silicon oxide film on the substrate above the element, forming a film body having a through hole on the opposite side of the silicon oxide film from the substrate, forming a pressure reference chamber by removing a part of the silicon oxide film through etching through the through hole, sealing the through hole, and forming a diaphragm portion in which the element is arranged by forming a recess portion on a surface on the opposite side of the substrate from the pressure reference chamber.

According to the method for manufacturing a physical quantity sensor, the pressure reference chamber is formed by using a CMOS process. This can increase the accuracy of positioning the diaphragm portion, the element having a strain resistance, and the pressure reference chamber and can decrease the obtained physical quantity sensor in size.

### Application Example 8

It is preferable that the method for manufacturing a physical quantity sensor according to the application example further includes forming a silicon nitride film on the substrate above the element prior to the forming the silicon oxide film.

The silicon nitride film has not only insulating characteristics but also a resistance to buffered hydrofluoric acid and the like used in the etch of the silicon oxide film. Accordingly, the silicon nitride film can be used as an etching stopper layer at the time of the etch of the silicon oxide film.

### Application Example 9

A pressure sensor according to this application example includes the physical quantity sensor according to the application example.

Accordingly, there can be provided the pressure sensor including the physical quantity sensor that can increase the accuracy of positioning the diaphragm portion and the element having a strain resistance and can be decreased in size.

### Application Example 10

An altimeter according to this application example includes the physical quantity sensor according to the application example.

Accordingly, there can be provided the altimeter including the physical quantity sensor that can increase the accuracy of positioning the diaphragm portion and the element having a strain resistance and can be decreased in size.

### Application Example 11

An electronic device according to this application example includes the physical quantity sensor according to the application example.

Accordingly, there can be provided the electronic device including the physical quantity sensor that can increase the accuracy of positioning the diaphragm portion and the element having a strain resistance and can be decreased in size.

### Application Example 12

A moving object according to this application example includes the physical quantity sensor according to the application example.

Accordingly, there can be provided the moving object including the physical quantity sensor that can increase the accuracy of positioning the diaphragm portion and the element having a strain resistance and can be decreased in size.

### BRIEF DESCRIPTION OF THE DRAWINGS

The invention will be described with reference to the accompanying drawings, wherein like numbers reference like elements.

FIG. 1 is a cross-sectional view illustrating a physical quantity sensor according to an embodiment of the invention.

FIG. 2 is a plan view illustrating an enlarged arrangement of a piezoresistive element of the physical quantity sensor illustrated in FIG. 1.

FIGS. 3A and 3B are diagrams for describing the operation of the physical quantity sensor illustrated in FIG. 1. FIG. 3A is a cross-sectional view illustrating a pressurization state, and FIG. 3B is a plan view illustrating a pressurization state.

FIGS. 4A to 4E are diagrams illustrating a process of manufacturing the physical quantity sensor illustrated in FIG. 1.

FIGS. 5A to 5D are diagrams illustrating the process of manufacturing the physical quantity sensor illustrated in FIG. 1.

FIGS. 6A and 6B are diagrams illustrating the process of manufacturing the physical quantity sensor illustrated in FIG. 1.

FIG. 7 is a cross-sectional view illustrating an example of a pressure sensor according to the invention.

FIG. 8 is a perspective view illustrating an example of an altimeter according to the invention.

FIG. 9 is a front view illustrating an example of an electronic device according to the invention.

FIG. 10 is a perspective view illustrating an example of a moving object according to the invention.

### DESCRIPTION OF EXEMPLARY EMBODIMENTS

Hereinafter, detailed descriptions will be provided for a physical quantity sensor, a method for manufacturing the physical quantity sensor, a pressure sensor, an altimeter, an electronic device, and a moving object according to the invention on the basis of each embodiment illustrated in the appended drawings.

### First Embodiment

### 1. Physical Quantity Sensor

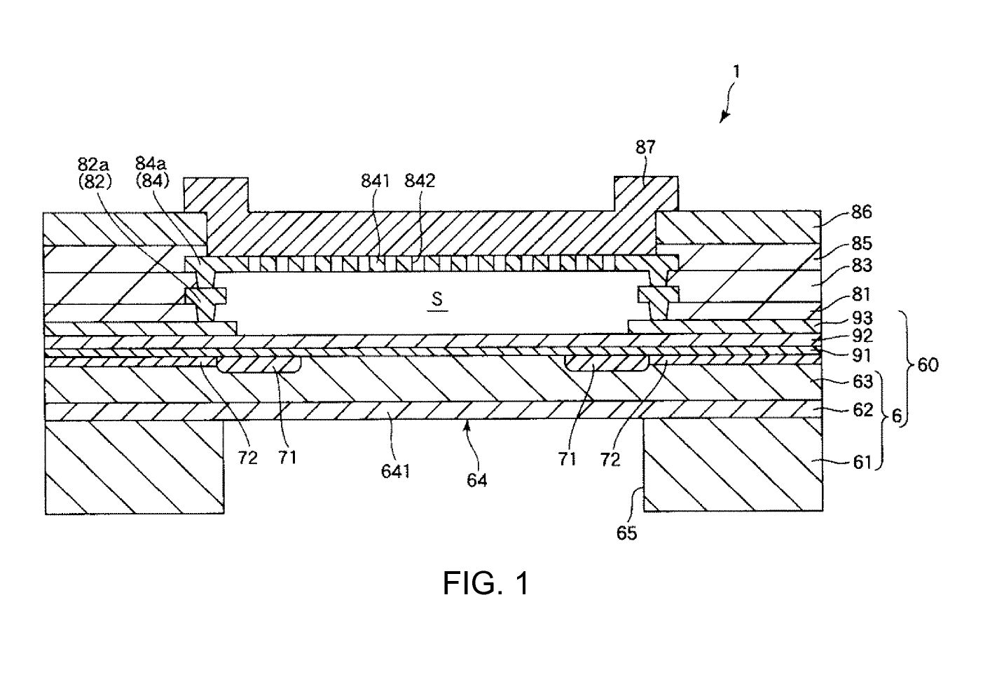

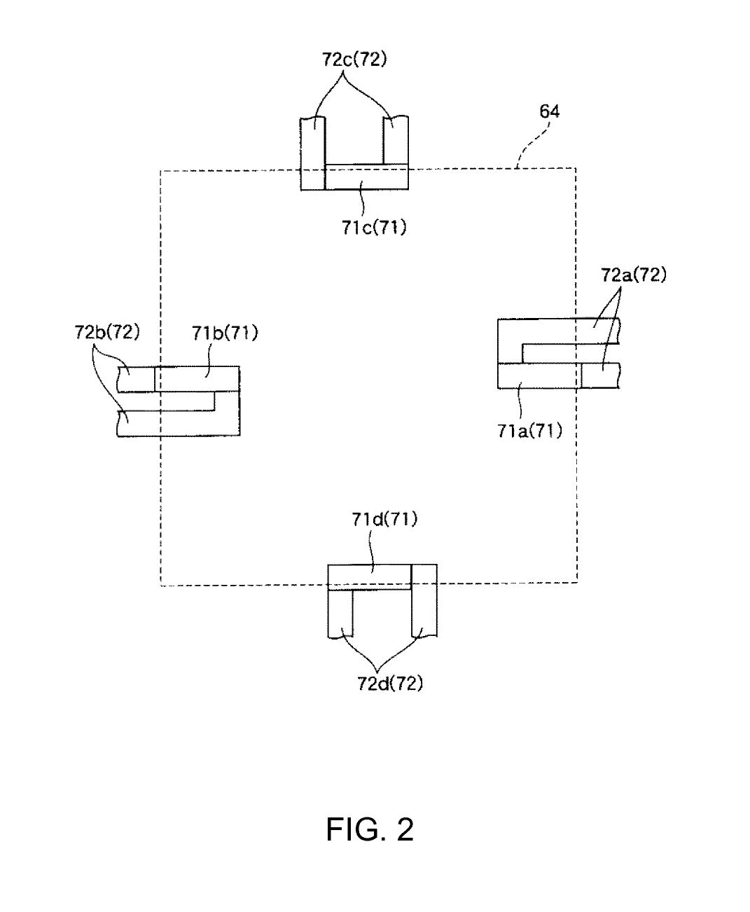

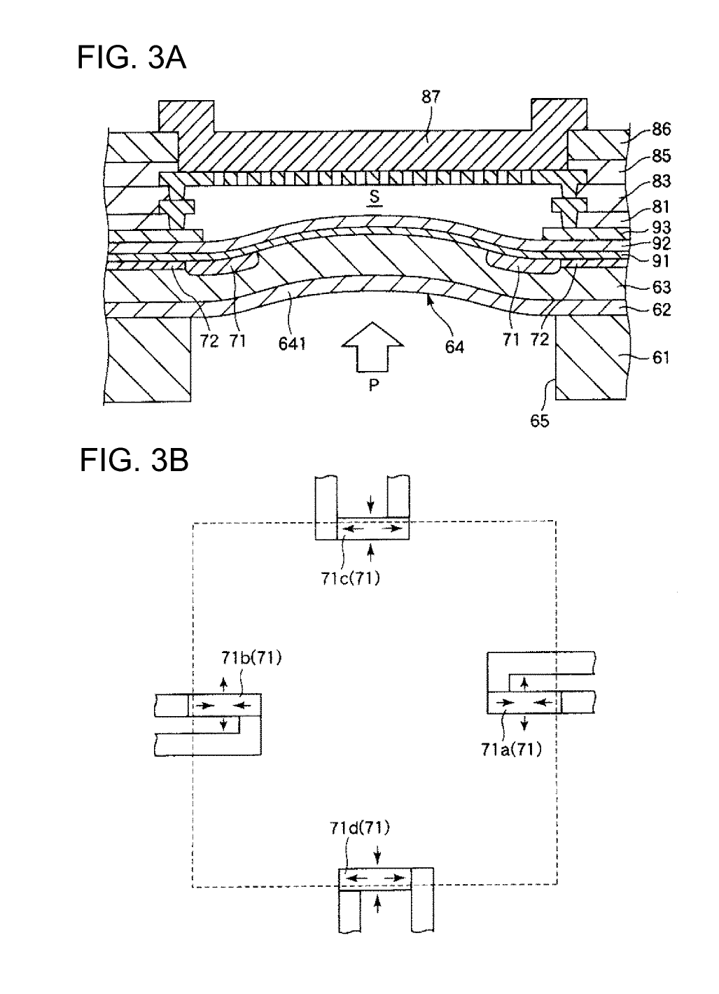

FIG. 1 is a cross-sectional view illustrating a physical quantity sensor according to an embodiment of the invention. FIG. 2 is a plan view illustrating the enlarged arrangement of a piezoresistive element of the physical quantity sensor illustrated in FIG. 1. FIGS. 3A and 3B are diagrams for describing the operation of the physical quantity sensor illustrated in FIG. 1. FIG. 3A is a cross-sectional view illustrating a pressurization state, and FIG. 3B is a plan view illustrating a pressurization state. An upper side in FIG. 1 is referred to as “on” and a lower side as “under” hereinafter for convenience of description.

A physical quantity sensor 1 illustrated in FIG. 1 is provided with a substrate 6 and a laminated structure 8. The laminated structure 8 is disposed on the upper surface of the substrate 6 with a silicon oxide film 91, a silicon nitride film 92, and a polysilicon film 93 interposed therebetween. A substrate 60 is a laminated body configured by the substrate 6, the silicon oxide film 91, the silicon nitride film 92, and the polysilicon film 93. The substrate 60 has a diaphragm portion 64. A plurality of piezoresistive elements 71 (strain detecting element) is arranged in the diaphragm portion 64. The part of the laminated structure 8 corresponding to the diaphragm portion 64 is separate from the substrate 60. Accordingly, a cavity portion S (pressure reference chamber) is formed between the part and the substrate 60.

Hereinafter, descriptions will be sequentially provided for each unit constituting the physical quantity sensor 1.

### Substrate

The substrate 6 is an SOI substrate in which a silicon layer 61 (handle layer) configured of monocrystalline silicon, a silicon oxide layer 62 (box layer) configured by a silicon oxide film, and a silicon layer 63 (device layer) configured of monocrystalline silicon are stacked in this order. The substrate 6 is not limited to an SOI substrate and, for example, may be other semiconductor substrates such as a monocrystalline silicon substrate.

The silicon oxide film 91, the silicon nitride film 92, and the polysilicon film 93 are stacked in this order on the upper surface of the silicon layer 63 of the substrate 6. The silicon oxide film 91 and the silicon nitride film 92 each function as an insulating film. The silicon nitride film 92 also functions as an etching stopper layer used in forming the cavity portion S in a process of manufacturing the physical quantity sensor 1. The process will be described later. The silicon oxide film 91 also has a function of reducing stress between the silicon layer 63 and the silicon nitride film 92.

The polysilicon film 93 is configured of polysilicon (polycrystalline silicon) doped (diffused or implanted) with impurities such as phosphorus and boron. The polysilicon film 93 has conductivity. For this, a part of the polysilicon film 93 can be used as the gate electrode of an MOS transistor when, for example, an MOS transistor is formed on the substrate 6 outside the cavity portion S. Although a part of the polysilicon film 93 is exposed to the cavity portion S in the present embodiment, the entire polysilicon film 93 may be positioned outside the cavity portion S. In addition, the polysilicon film 93 may be omitted.

The diaphragm portion 64 is disposed in the substrate 60 configured by the substrate 6, the silicon oxide film 91, the silicon nitride film 92, and the polysilicon film 93. The diaphragm portion 64 is thinner than the surrounding part thereof and is flexibly deformed when receiving pressure. The diaphragm portion 64 is formed by disposing a recess portion 65 that has a bottom on the lower surface of the substrate 6. The lower surface of the diaphragm portion 64 is a pressure receiving surface 641. In the present embodiment, the diaphragm portion 64 has a shape of a square in a plan view as illustrated in FIG. 2.

The recess portion 65 penetrates the silicon layer 61, and a part of the polysilicon film 93 is omitted in the area corresponding to the recess portion 65 in the substrate 60 in the present embodiment. The diaphragm portion 64 is configured by four layers of the silicon oxide layer 62, the silicon layer 63, the silicon oxide film 91, and the silicon nitride film 92. Here, the silicon oxide layer 62 can be used as an etching stopper layer when the recess portion 65 is formed through etching in the process of manufacturing the physical quantity sensor 1 as will be described later. This can reduce variations in the thickness of the diaphragm portion 64 for each product.

The recess portion 65 may not penetrate the silicon layer 61, and the diaphragm portion 64 may be configured by five layers of a thinned portion of the silicon layer 61, the silicon oxide layer 62, the silicon layer 63, the silicon oxide film 91, and the silicon nitride film 92.

### Piezoresistive Element

Each of the plurality of piezoresistive elements 71 is formed on the cavity portion S side of the diaphragm portion 64 as illustrated in FIG. 1. The piezoresistive element 71 is formed in the silicon layer 63 of the substrate 6.

The plurality of piezoresistive elements 71 is configured by a plurality of piezoresistive elements 71a, 71b, 71c, and 71d that is arranged in the periphery portion of the diaphragm portion 64 as illustrated in FIG. 2.

The piezoresistive element 71a, the piezoresistive element 71b, the piezoresistive element 71c, and the piezoresistive element 71d are arranged corresponding to the four edges of the diaphragm portion 64 having a shape of a quadrangle in a plan view.

The piezoresistive element 71a extends along the direction that is perpendicular to the corresponding edge of the diaphragm portion 64. A pair of pieces of wiring 72a is electrically connected to both end portions of the piezoresistive element 71a. Similarly, the piezoresistive element 71b extends along the direction that is perpendicular to the corresponding edge of the diaphragm portion 64. A pair of pieces of wiring 72b is electrically connected to both end portions of the piezoresistive element 71b.

Meanwhile, the piezoresistive element 71c extends along the direction that is parallel to the corresponding edge of the diaphragm portion 64. A pair of pieces of wiring 72c is electrically connected to both end portions of the piezoresistive element 71c. Similarly, the piezoresistive element 71d extends along the direction that is parallel to the corresponding edge of the diaphragm portion 64. A pair of pieces of wiring 72d is electrically connected to both end portions of the piezoresistive element 71d.

The pieces of wiring 72a, 72b, 72c, and 72d may be collectively referred to as “wiring 72” hereinafter.

Each of the piezoresistive element 71 and the wiring 72, for example, is configured of silicon (monocrystalline silicon) doped (diffused or implanted) with impurities such as phosphorus and boron. Here, the concentration of the impurities that the wiring 72 is doped with is greater than the concentration of the impurities that the piezoresistive element 71 is doped with. The wiring 72 may be configured of metal.

The plurality of piezoresistive elements 71 is configured to have equal resistance values in a natural state.

The piezoresistive element 71 described above constitutes a bridge circuit (Wheatstone bridge circuit) through the wiring 72 and the like. The bridge circuit is connected to a drive circuit (not illustrated) that supplies a drive voltage to the bridge circuit. The bridge circuit outputs a signal (voltage) corresponding to the resistance value of the piezoresistive element 71.

### Laminated Structure

The laminated structure 8 is formed to section the cavity portion S between the laminated structure 8 and the substrate 60 described above. The laminated structure 8 is a “wall portion” that is arranged on the piezoresistive element 71 side of the diaphragm portion 64 and constitutes the cavity portion S (pressure reference chamber) with the diaphragm portion 64.

The laminated structure 8 includes an interposed insulating film 81, a wiring layer 82, an interposed insulating film 83, a wiring layer 84, an insulating film 85, a surface protective film 86, and a sealing layer 87. The interposed insulating film 81 is formed to enclose the piezoresistive element 71 on the substrate 60 in a plan view. The wiring layer is formed on the interposed insulating film 81. The interposed insulating film 83 is formed on the wiring layer 82 and the interposed insulating film 81. The wiring layer includes a cladding layer 841 that is formed on the interposed insulating film 83 and is provided with a plurality of pores (opening). The insulating film 85 is formed on the wiring layer 84 and the interposed insulating film 83. The surface protective film 86 is disposed on the insulating film 85. The sealing layer 87 is disposed on the cladding layer 841.

Each of the interposed insulating films 81 and 83 is configured by, for example, a silicon oxide film.

The wiring layer 82 here includes a wiring layer 82a that is formed to enclose the cavity portion S. The wiring layer 84 includes a wiring layer 84a that is formed to enclose the cavity portion S.

The laminated structure 8 can be formed by using a semiconductor manufacturing process such as a CMOS process. A semiconductor circuit may be fabricated on and above the silicon layer 63. The semiconductor circuit includes an active element such as an MOS transistor and other circuit elements such as a capacitor, an inductor, a resistor, a diode, and wiring (including wiring connected to the piezoresistive element 71) that are formed when necessary.

### Cavity Portion

The cavity portion S sectioned by the substrate 60 and the laminated structure 8 is an airtight space. The cavity portion S functions as a pressure reference chamber. The pressure in the pressure reference chamber serves as the reference value for the pressure that the physical quantity sensor 1 detects. The cavity portion S is set to be in the vacuum state (less than or equal to 300 Pa) in the present embodiment. By setting the cavity portion S to be in the vacuum state, the physical quantity sensor 1 can be used as an “absolute pressure sensor” that detects pressure with the pressure in the vacuum state as a reference. This improves the convenience of use of the physical quantity sensor 1.

The cavity portion S may not be in the vacuum state. The cavity portion S may be under atmospheric pressure, may be in a depressurization state where the pressure is below atmospheric pressure, or may be in a pressurization state where the pressure is above atmospheric pressure. In addition, inert gases such as nitrogen gas and a noble gas may be sealed in the cavity portion S.

The configuration of the physical quantity sensor 1 is briefly described hereinbefore.

In the physical quantity sensor 1 having such a configuration, the diaphragm portion 64 is deformed in response to the pressure that the pressure receiving surface 641 of the diaphragm portion 64 receives as illustrated in FIG. 3A. Accordingly, the piezoresistive elements 71a, 71b, 71c, and 71d are strained as illustrated in FIG. 3B, and this changes the resistance value of the piezoresistive elements 71a, 71b, 71c, and 71d. Accordingly, a change occurs in the output of the bridge circuit configured by the piezoresistive elements 71a, 71b, 71c, and 71d, and the magnitude of the pressure received by the pressure receiving surface 641 can be obtained on the basis of the output.

To describe more specifically, the product of the resistance values of the piezoresistive elements 71a and 71b is equal to the product of the resistance values of the piezoresistive elements 71c and 71d in a natural state prior to the above-described deformation of the diaphragm portion 64 since the resistance values of the piezoresistive elements 71a, 71b, 71c, and 71d are equal to each other. Thus, the output (electric potential difference) of the bridge circuit becomes zero.

Meanwhile, when the diaphragm portion 64 is deformed as described above, a compressive strain and a tensile strain occur respectively along the longitudinal direction and the width direction of the piezoresistive elements 71a and 71b, and a tensile strain and a compressive strain occur respectively along the longitudinal direction and the width direction of the piezoresistive elements 71c and 71d as illustrated in FIG. 3B. Accordingly, one of the resistance value of the piezoresistive elements 71a and 71b and the resistance value of the piezoresistive elements 71c and 71d increases, and the other decreases when the diaphragm portion 64 is deformed as described above.

Such strains in the piezoresistive elements 71a, 71b, 71c, and 71d cause a difference between the product of the resistance values of the piezoresistive elements 71a and 71b and the product of the resistance values of the piezoresistive elements 71c and 71d. Thus, an output (electric potential difference) corresponding to the difference is output from the bridge circuit. The magnitude (absolute pressure) of the pressure received by the pressure receiving surface 641 can be obtained on the basis of the output from the bridge circuit.

Since one of the resistance value of the piezoresistive elements 71a and 71b and the resistance value of the piezoresistive elements 71c and 71d increases, and the other decreases when the diaphragm portion 64 is deformed as described above, a change in the difference between the product of the resistance values of the piezoresistive elements 71a and 71b and the product of the resistance values of the piezoresistive elements 71c and 71d can be increased. Accordingly, the output from the bridge circuit can be increased. As a result, the pressure detection sensitivity can be increased. In addition, all the temperature sensitivities of the piezoresistive elements 71a, 71b, 71c, and 71d constituting the bridge circuit are substantially the same. This can reduce a change in characteristics thereof accompanied by a change in the external temperature.

As will be described later, the laminated structure (wall portion) is formed by using a CMOS process in the physical quantity sensor 1 above. This can increase the accuracy of positioning the diaphragm portion 64, the piezoresistive element 71, and the cavity portion S and can decrease the physical quantity sensor 1 in size.

The wiring layers 82 and 84 of the laminated structure 8 are configured of a conductive material such as aluminum as will be described later. Accordingly, a conductive material is included in the part of the laminated structure 8 that overlaps with the piezoresistive element 71 (that is, a ceiling portion including the cladding layer 841 and the sealing layer 87) in a plan view from the thickness direction of the diaphragm portion 64. For this, the part of the laminated structure 8 facing the diaphragm portion 64 (ceiling portion) has conductivity.

The silicon oxide film 91 and the silicon nitride film 92, which are insulating films, are arranged between the piezoresistive element 71 and the cavity portion S. This can prevent the piezoresistive element 71 or the wiring 72 from being short-circuited even when the part of the laminated structure 8 facing the diaphragm portion 64 (that is, the ceiling portion including the cladding layer 841 and the sealing layer 87) has conductivity, bends inward, and comes in contact with the diaphragm portion 64.

The silicon nitride film 92 has not only insulating characteristics but also a resistance to buffered hydrofluoric acid. For this, the silicon nitride film 92 can be used as an etching stopper layer when the cavity portion S is formed by etching a silicon oxide film with buffered hydrofluoric acid and the like.

The silicon oxide film 91 has insulating characteristics. Arranging the silicon oxide film 91 between the silicon nitride film 92 and the piezoresistive element 71 can reduce stress between the silicon nitride film 92 and the piezoresistive element 71.

The thickness of the silicon nitride film 92 is preferably less than the thickness of the silicon oxide film 91 provided that the silicon oxide film 91 secures necessary insulating characteristics, and the silicon nitride film 92 secures a necessary resistance to etching liquids. Accordingly, the silicon nitride film 92 can be thinned to reduce stress on the silicon nitride film 92 as described above. In addition, the thickness of the silicon oxide film 91 can be increased to reduce stress between the silicon nitride film 92 and the piezoresistive element 71 effectively with the silicon oxide film 91. Increasing the thickness of the silicon oxide film 91 can secure necessary insulating characteristics for the silicon oxide film 91 even when the silicon nitride film 92 is dramatically thinned to diminish insulating characteristics thereof. In addition, the silicon nitride film 92 can secure a necessary resistance to etching liquids as described above even when the silicon nitride film 92 is dramatically thinned to diminish insulating characteristics thereof.

The specific thickness of the silicon oxide film 91 is not particularly limited and is approximately between 0.01 μm and 0.5 μm inclusive. The specific thickness of the silicon nitride film 92 is not particularly limited and is approximately between 0.01 μm and 0.5 μm inclusive.

### Method for Manufacturing Physical Quantity Sensor

Next, a brief description will be provided for a method for manufacturing the physical quantity sensor 1.

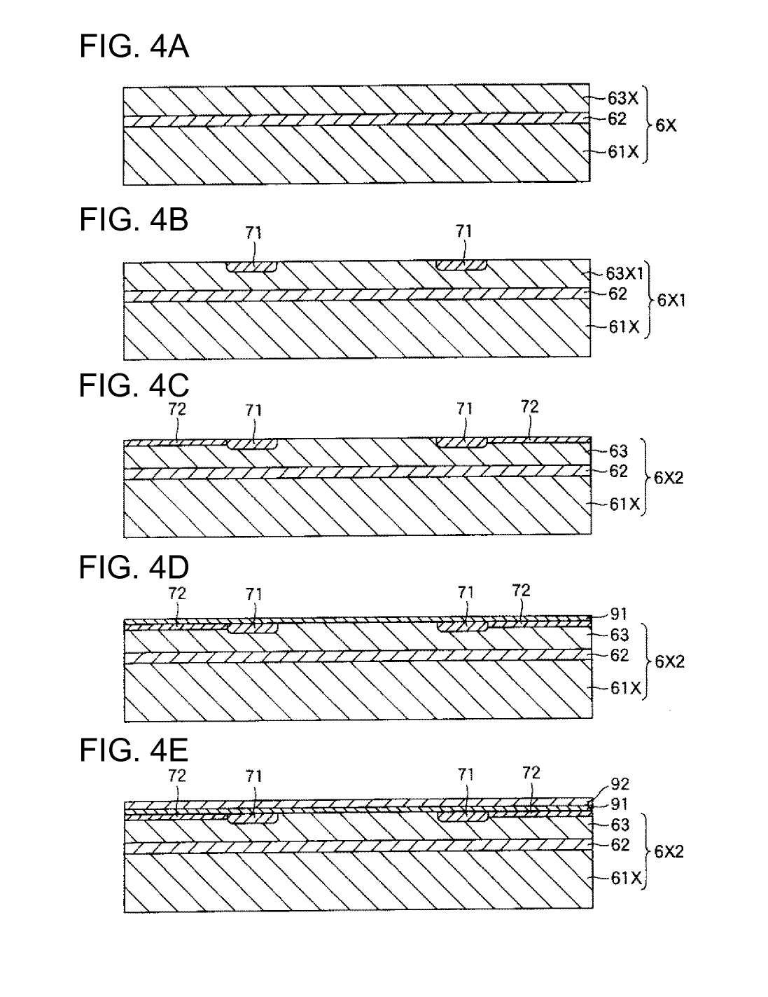

FIG. 4A to FIG. 6B are diagrams illustrating the process of manufacturing the physical quantity sensor 1 illustrated in FIG. 1. A description will be provided below on the basis of these drawings.

### Process of Forming Strain Detecting Element

First, a substrate 6X which is an SOI substrate is prepared as illustrated in FIG. 4A. The substrate 6X has a silicon layer 61X (handle layer) configured of monocrystalline silicon, the silicon oxide layer 62 (box layer) configured by a silicon oxide film, and a silicon layer 63X configured of monocrystalline silicon, all of which are stacked in this order in the substrate 6X. In a later process, after thinned through polishing and the like when necessary, the silicon layer 61X becomes the silicon layer 61 with the recess portion 65 formed therein.

Next, the silicon layer 63X is doped with (implanted with ions of) impurities such as phosphorus (n-type) or boron (p-type) to form the piezoresistive element 71 as illustrated in FIG. 4B. Accordingly, a silicon layer 63X1 is obtained in which the piezoresistive element 71 is formed.

The concentration of ions implanted into the piezoresistive element 71 is approximately 1×10¹⁴ atoms/cm² when, for example, boron ions are implanted at an energy of +80 keV. In addition, annealing is performed at, for example, approximately 1000° C. for approximately 20 minutes after the implantation of ions.

Next, the silicon layer 63X1 is doped with (implanted with ions of) impurities such as phosphorus or boron to form the wiring 72 as illustrated in FIG. 4C. Accordingly, the silicon layer 63 is obtained in which the piezoresistive element 71 and the wiring 72 are formed.

Conditions and the like for implantation of ions are adjusted for this implantation of ions so that the amount of impurities doped into the wiring 72 is greater than that of impurities doped into the piezoresistive element 71. For example, the concentration of ions implanted into the wiring 72 is approximately 5×10¹⁵ atoms/cm² when boron ions are implanted at an energy of 10 keV. In addition, annealing is performed at, for example, approximately 1000° C. for approximately 20 minutes after the implantation of ions.

### Process of Forming Insulating Film and the Like

Next, the silicon oxide film 91 is formed on the silicon layer 63 as illustrated in FIG. 4D. The silicon oxide film 91 can be formed through, for example, sputtering, CVD or the like.

Next, the silicon nitride film 92 is formed on the silicon oxide film 91 as illustrated in FIG. 4E. The silicon nitride film 92 can be formed through, for example, sputtering, CVD or the like.

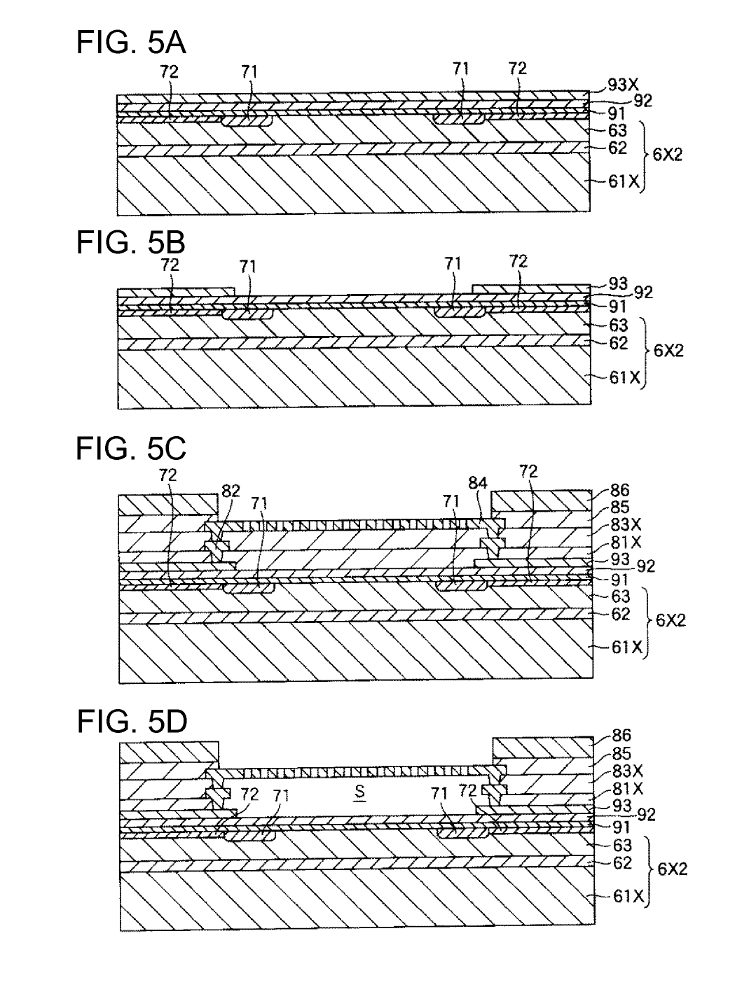

Next, a polysilicon film 93X is formed on the silicon nitride film 92 as illustrated in FIG. 5A.

The polysilicon film 93X is formed by, for example, depositing polycrystalline silicon through sputtering, CVD, or the like and doping the deposited film with (implanting with ions of) impurities such as phosphorus or boron.

The thickness of the polysilicon film 93X is not particularly limited and, for example, is approximately between 200 nm and 400 nm inclusive.

Next, the polysilicon film 93 is obtained by patterning the polysilicon film 93X through etching as illustrated in FIG. 5B. A gate electrode of an MOS transistor can be formed at this time when necessary.

### Process of Forming Interposed Insulating Film and Wiring Layer

Next, interposed insulating films 81X and 83X, the wiring layers 82 and 84, the insulating film 85, and the surface protective film 86 are formed on the silicon nitride film 92 and the polysilicon film 93 as illustrated in FIG. 5C.

The interposed insulating films 81X and 83X are formed by forming a silicon oxide film through sputtering, CVD, or the like and patterning the silicon oxide film through etching.

The thickness of each of the interposed insulating films 81X and 83X is not particularly limited and, for example, is approximately between 1500 nm and 5000 nm inclusive.

The wiring layers 82 and 84 are formed by, for example, forming an aluminum layer on the interposed insulating films 81X and 83X through sputtering, CVD, or the like and patterning the aluminum layer.

The thickness of each of the wiring layers 82 and is not particularly limited and, for example, is approximately between 300 nm and 900 nm inclusive.

Such a laminated structure of the interposed insulating films 81X and 83X and the wiring layers 82 and 84 is formed through a typical CMOS process, and the number of laminated layers is appropriately set, depending on the necessity thereof. That is to say, there may be a case where a greater number of wiring layers are stacked with the interposed insulating films interposed therebetween, depending on the necessity thereof.

The insulating film 85 and the surface protective film 86 are formed in this order through sputtering, CVD, or the like after the interposed insulating films 81X and 83X and the wiring layers 82 and 84 are formed. Materials such as a silicon oxide film, a silicon nitride film, a polyimide film, and an epoxy resin film are exemplified as the material of each of the insulating film 85 and the surface protective film 86. These materials have a resistance to protect elements from moisture, dust, scratches, and the like. For example, the insulating film 85 is configured by a silicon oxide film, and the surface protective film 86 is configured by a silicon nitride film.

The thickness of each of the insulating film 85 and the surface protective film 86 is not particularly limited and, for example, is approximately between 500 nm and 2000 nm inclusive.

### Process of Forming Cavity Portion

Next, the cavity portion S is formed by removing a part of the interposed insulating films 81X and 83X as illustrated in FIG. 5D. Accordingly, the interposed insulating films 81 and 83 are formed.

The cavity portion S is formed by removing a part of the interposed insulating films 81X and 83X through etching through a plurality of pores 842 formed in the cladding layer 841. When wet etching is used here, an etching liquid such as hydrofluoric acid or buffered hydrofluoric acid is supplied from the plurality of pores 842. When dry etching is used, an etching gas such as hydrofluoric acid gas is supplied from the plurality of pores 842. The silicon nitride film 92 functions as an etching stopper layer at the time of etching. In addition, since having a resistance to etching liquids, the silicon nitride film 92 has a function of protecting constituents under the silicon nitride film 92 (for example, the silicon oxide film 91, the piezoresistive element 71, and the wiring 72) from etching liquids.

### Sealing Process

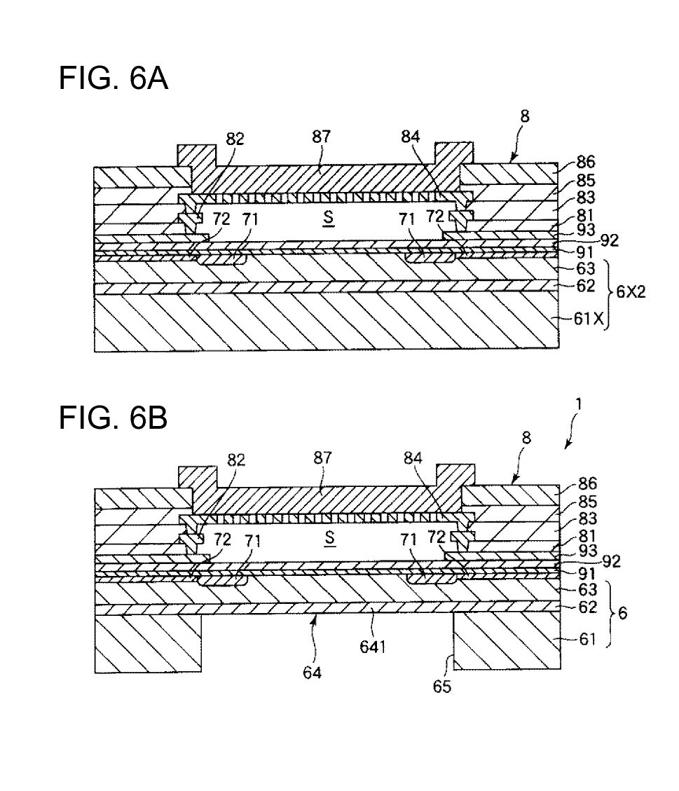

Next, the sealing layer 87 is formed on the cladding layer 841 through sputtering, CVD, or the like to seal each pore 842 as illustrated in FIG. 6A. The sealing layer 87 is configured by a silicon oxide film, a silicon nitride film, and a film of metal such as Al, Cu, W, Ti, and TiN. Accordingly, the cavity portion S is sealed by the sealing layer 87, and the laminated structure 8 is obtained.

The thickness of the sealing layer 87 is not particularly limited and, for example, is approximately between 1000 nm and 5000 nm inclusive.

### Process of Forming Diaphragm

Next, the recess portion 65 is formed as illustrated in FIG. 6B by removing a part of the lower surface of the silicon layer 61X through etching after grinding the lower surface of the silicon layer 61X when necessary. Accordingly, the diaphragm portion 64 is formed that is thinner than the surrounding part thereof.

The silicon oxide layer 62 functions as an etching stopper layer when a part of the lower surface of the silicon layer 61X is removed. Accordingly, the thickness of the diaphragm portion 64 can be defined with high accuracy.

Any of dry etching, wet etching, and the like may be used as a method for removing a part of the lower surface of the silicon layer 61X.

The physical quantity sensor 1 is manufactured according to the processes described above.

The above-described method for manufacturing the physical quantity sensor 1 includes the process of forming the piezoresistive element 71 on one surface of a substrate 6X1 (refer to FIG. 4B), the process of forming the interposed insulating films 81X and 83X (silicon oxide films) covering the piezoresistive element 71 on the piezoresistive element 71 side of a substrate 6X2 (refer to FIG. 5C), the process of forming the cladding layer 841 (film body) including the pores 842 (through holes) on the opposite side of the interposed insulating films 81X and 83X from the substrate 6X2 (refer to FIG. 5C), the process of forming the cavity portion S by removing a part of the interposed insulating films 81X and 83X through etching through the pores 842 (refer to FIG. 5D), the process of sealing the pores 842 (refer to FIG. 6A), and the process of forming the diaphragm portion 64 having the piezoresistive element 71 arranged therein by forming the recess portion 65 on the opposite side of the substrate 6 from the cavity portion S (refer to FIG. 6B).

The cavity portion S (laminated structure 8) is formed by using a CMOS process according to the method for manufacturing the physical quantity sensor 1. This can increase the accuracy of positioning the diaphragm portion 64, the piezoresistive element 71, and the cavity portion S and decrease the obtained physical quantity sensor 1 in size.

The above-described method for manufacturing the physical quantity sensor 1 includes the process of forming the silicon nitride film 92 covering the piezoresistive element 71 prior to the forming of the interposed insulating films 81X and 83X. The silicon nitride film 92 has not only insulating characteristics but also a resistance to buffered hydrofluoric acid and the like used in the etch of the interposed insulating films 81X and 83X. For this, the silicon nitride film 92 can be used as an etching stopper layer at the time of the etch of the interposed insulating films 81X and 83X.

### 2. Pressure Sensor

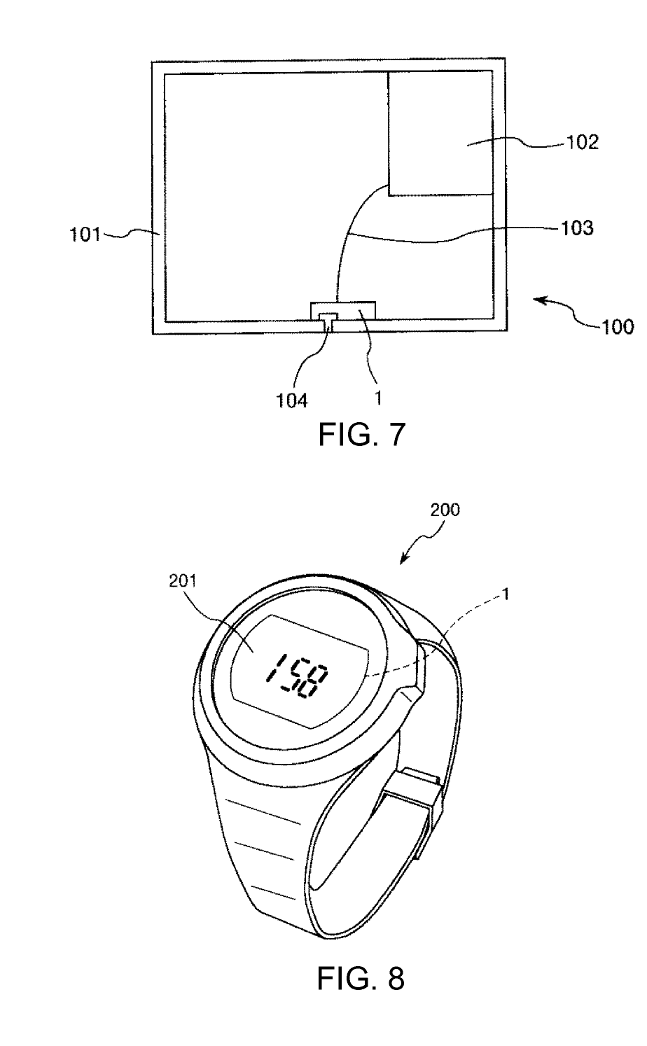

Next, a description will be provided for a pressure sensor (the pressure sensor according to the invention) that is provided with the physical quantity sensor according to the invention. FIG. 7 is a cross-sectional view illustrating an example of the pressure sensor according to the invention.

A pressure sensor 100 according to the invention is provided with the physical quantity sensor 1, a casing 101, and a calculation unit 102 as illustrated in FIG. 7. The casing 101 accommodates the physical quantity sensor 1. The calculation unit 102 calculates pressure data from a signal obtained from the physical quantity sensor 1. The physical quantity sensor 1 is electrically connected to the calculation unit 102 through wiring 103.

The physical quantity sensor 1 is fixed inside the casing 101 by an unillustrated fixing unit. The casing 101, for example, includes a through hole 104 used for the diaphragm portion 64 of the physical quantity sensor 1 to communicate with the atmosphere (outside of the casing 101).

The diaphragm portion 64 receives pressure through the through hole 104 according to the pressure sensor 100. The received pressure signal is transmitted to the calculation unit through the wiring 103, and pressure data is calculated from the signal. The calculated pressure data can be displayed via an unillustrated display unit (for example, a monitor of a personal computer and the like).

### 3. Altimeter

Next, a description will be provided for an altimeter (the altimeter according to the invention) that is provided with the physical quantity sensor according to the invention. FIG. 8 is a perspective view illustrating an example of the altimeter according to the invention.

An altimeter 200 can be worn on a wrist like a wristwatch. The physical quantity sensor 1 (pressure sensor 100) is mounted inside the altimeter 200. A display unit 201 can display the altitude of a current location above sea level or the atmospheric pressure and the like of a current location.

The display unit 201 can display a variety of information such as a current time, the heart rate of a user, weather, and the like.

### 4. Electronic Device

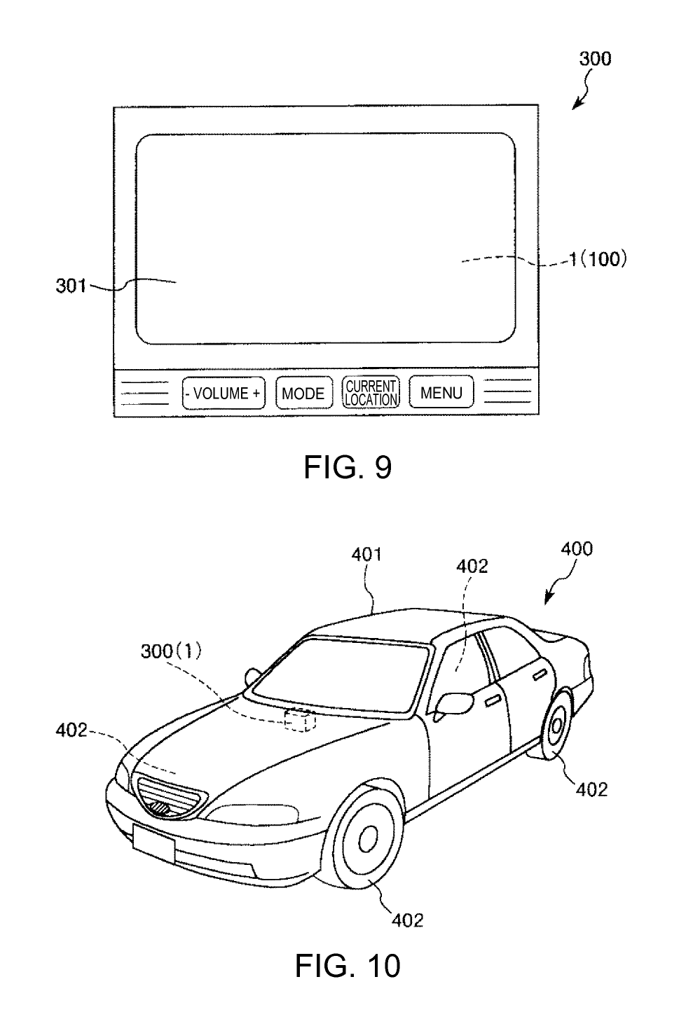

Next, a description will be provided for a navigation system to which an electronic device provided with the physical quantity sensor according to the invention is applied. FIG. 9 is a front view illustrating an example of the electronic device according to the invention.

A navigation system 300 is provided with unillustrated map information; a position information obtaining unit configured by a global positioning system (GPS); a self-contained navigation unit configured by a gyro sensor, an acceleration sensor, and vehicle speed data; the physical quantity sensor 1; and a display unit 301 displaying predetermined position information or course information.

The navigation system can obtain altitude information in addition to obtained position information. When, for example, a vehicle traverses an elevated road that is illustrated at approximately the same position as that of a typical road on position information, a navigation system cannot determine whether the vehicle traverses a typical road or an elevated road without having altitude information and thus provides a user with information on a typical road as prioritized information. The navigation system 300 according to the present embodiment can obtain altitude information with the physical quantity sensor 1 and can provide a user with navigation information on the traversing state of the vehicle on an elevated road by detecting a change in altitude caused by the vehicle entering an elevated road from a typical road.

The display unit 301 is configured by, for example, a liquid crystal panel display or an organic electroluminescence (EL) display and can be decreased in size and thickness.

The electronic device provided with the physical quantity sensor according to the invention is not limited to the above examples and, for example, can be applied to a personal computer, a cellular phone, a medical device (for example, an electronic thermometer, a sphygmomanometer, a blood glucose meter, an electrocardiograph, an ultrasonic diagnostic device, and an electronic endoscope), various measuring devices, meters (for example, meters of a vehicle, an airplane, and a ship), a flight simulator and the like.

### 5. Moving object

Next, a description will be provided for a moving object (the moving object according to the invention) to which the physical quantity sensor according to the invention is applied. FIG. 10 is a perspective view illustrating an example of the moving object according to the invention.

A moving object 400 includes a vehicle body 401 and four wheels 402 as illustrated in FIG. 10. The moving object 400 is configured in a manner in which an unillustrated power source (engine) disposed in the vehicle body 401 rotates the wheels 402. The navigation system 300 (physical quantity sensor 1) is incorporated into the moving object 400.

While descriptions are provided for the physical quantity sensor, the method for manufacturing the physical quantity sensor, the pressure sensor, the altimeter, the electronic device, and the moving object according to the invention on the basis of each illustrated embodiment, the invention is not limited to these embodiments. The configuration of each unit can be substituted by any configuration having the same function. In addition, any other constituents or processes may be added thereto.

The number of piezoresistive elements disposed in one diaphragm portion is not limited to that in the embodiment described above. For example, the number may be greater than or equal to one and less than or equal to three or may be greater than or equal to five. The arrangement or the shape of the piezoresistive element is not limited to that in the embodiment described above. For example, the piezoresistive element may also be arranged inside the diaphragm portion in the above-described embodiment.

In the embodiment described above, a description is provided for a case where the silicon nitride film is used as an etching stopper layer when the pressure reference chamber is formed by removing a part of the silicon oxide film through etching. However, instead of the silicon nitride film, a polysilicon film that is not doped or an amorphous silicon film may be disposed, and the polysilicon film or the amorphous silicon film may be used as an etching stopper layer. In this case, an insulating film such as a silicon oxide film is preferably disposed between the polysilicon film or the amorphous silicon film and the strain detecting element.

The entire disclosure of Japanese Patent Application No. 2014-059811, filed Mar. 24, 2014 is expressly incorporated by reference herein.

What is claimed is:

1. A physical quantity sensor comprising:
a substrate that has a diaphragm portion deformed flexibly when receiving pressure;
an element that is arranged in the diaphragm portion and outputs a signal in response to a strain; and
a wall portion that constitutes a pressure reference chamber with the diaphragm portion,
wherein the wall portion includes a wiring layer.

2. The physical quantity sensor according to claim 1, further comprising an insulating film that is arranged between the element and the pressure reference chamber.

3. The physical quantity sensor according to claim 2, wherein the insulating film includes a silicon nitride film.

4. The physical quantity sensor according to claim 3, wherein the insulating film includes a silicon oxide film that is arranged between the silicon nitride film and the element detecting a strain.

5. The physical quantity sensor according to claim 2, wherein the wall portion has a part that includes a conductive material and overlaps the element in a plan view from the thickness direction of the diaphragm portion.

6. The physical quantity sensor according to claim 1, further comprising a corrosion-resistant film that is arranged between the element and the pressure reference chamber and has a corrosion resistance to buffered hydrofluoric acid.

7. A method for manufacturing a physical quantity sensor comprising:
forming on one surface of a substrate an element that outputs a signal in response to a strain;
forming a silicon oxide film on the substrate above the element;
forming a film body having a through hole on the opposite side of the silicon oxide film from the substrate;
forming a pressure reference chamber by removing a part of the silicon oxide film through etching through the through hole;
sealing the through hole; and
forming a diaphragm portion in which the element is arranged by forming a recess portion on a surface on the opposite side of the substrate from the pressure reference chamber.

8. The method for manufacturing a physical quantity sensor according to claim 7, further comprising forming a silicon nitride film on the substrate above the element prior to the forming the silicon oxide film.

9. A pressure sensor comprising the physical quantity sensor according to claim 1.

10. An altimeter comprising the physical quantity sensor according to claim 1.

11. An electronic device comprising the physical quantity sensor according to claim 1.

12. A moving object comprising the physical quantity sensor according to claim 1.
